(19) United States
(12) Patent Application Publication
(10) Pub. No.: US 2010/0245862 A1
(43) Pub. Date: Sep. 30, 2010

(54) IMAGE-PROCESSING DEVICE, IMAGE-FORMING DEVICE, IMAGE-PROCESSING METHOD, AND COMPUTER READABLE MEDIUM

(75) Inventors: Nozomi Noguchi, Yokohama-shi (JP); Shinichi Nakamura, Yokohama-shi (JP)

Correspondence Address: SUGHRUE MION, PLLC, 2100 PENNSYLVANIA AVENUE, N.W., SUITE 800, WASHINGTON, DC, 20037, US

(73) Assignee: FUJI XEROX CO., LTD., Tokyo (JP)

(21) Appl. No.: 12/564,950

(22) Filed: Sep. 23, 2009

(30) Foreign Application Priority Data
Mar. 25, 2009 (JP) 2009-075177

(51) Int. Cl. H04N 1/60; G06K 9/00

(52) U.S. Cl. 358/1.9; 382/162

(57) ABSTRACT

An image-processing device includes: an obtaining unit that obtains image data; an area extraction unit that extracts an area having a color falling within a predetermined range of a color, in an image represented by the image data obtained by the obtaining unit; a component extraction unit that extracts a component meeting a predetermined condition on a component of an image, in the image represented by the image data obtained by the obtaining unit; and a generating unit that if a component is extracted by the component extraction unit, that meets the predetermined condition, generates image data representing an image in which an effect of a type associated with the predetermined condition is applied to the area extracted by the area extraction unit.

### CROSS-REFERENCE TO RELATED APPLICATIONS

This application is based on and claims priority under 35 USC 119 from Japanese Patent Application No. 2009-075177 filed on Mar. 25, 2009.

### BACKGROUND

1. Technical Field

The present invention relates to an image-processing device, an image-forming device, an image-processing method, and a computer readable medium.

2. Related Art

A person having color weakness has difficulty in recognizing a certain range of a color. If a document is prepared with multiple colors, and the colors include a color that is difficult to recognize for a person having color weakness, an intended use of the color by a creator of the document may not be conveyed to the person having color weakness.

### SUMMARY

An aspect of the present invention provides an image-processing device including: a color storage unit that stores a range of a color within a color space; an effect storage unit that stores a set of a condition on a component of an image and a type of effect to be applied to an area having a color falling within the range of a color stored in the color storage unit, the area being included in an image having a component meeting the condition; an obtaining unit that obtains image data; an area extraction unit that extracts an area having a color falling within the range of a color stored in the color storage unit, in an image represented by the image data obtained by the obtaining unit; a component extraction unit that extracts a component meeting the condition stored in the effect storage unit, in the image represented by the image data obtained by the obtaining unit; and a generating unit that if a component is extracted by the component extraction unit, that meets the condition stored in the effect storage unit, generates image data representing an image in which an effect of the type stored in the effect storage unit in association with the condition is applied to the area extracted by the area extraction unit.

### BRIEF DESCRIPTION OF THE DRAWINGS

Exemplary embodiments of the present invention will be described in detail below with reference to the following figures, wherein:

FIG. 1 is a diagram showing an entire configuration of a system according to an exemplary embodiment of the present invention;

FIG. 2 is a block diagram showing a configuration of image-forming device 1;

FIG. 3 is a block diagram showing a configuration of image-processing device 3;

FIG. 4 is a diagram showing correspondence relations between a condition on a component of an image and a type of effect;

FIGS. 5A to 5F are diagrams showing an image of a character string;

FIGS. 6A to 6D are diagrams showing an image of a character string;

FIG. 7 is a flowchart showing an operation according to a first exemplary embodiment;

FIG. 8 is a diagram showing dialogue box 5;

FIG. 9 is a diagram showing correspondence relations between a condition on a component of an image and a type of effect;

FIG. 10 is a diagram showing a procedure of an operation according to a second exemplary embodiment;

FIG. 11 is a diagram showing an example of values of counters;

FIG. 12 is a diagram showing a procedure of an operation according to a third exemplary embodiment;

FIG. 13 is a diagram showing dialogue box 6;

FIG. 14 is a diagram showing dialogue box 7; and

FIGS. 15A and 15B are diagrams showing an image of a bar graph.

### DETAILED DESCRIPTION

### (1) First Exemplary Embodiment

### (1-1) Configuration

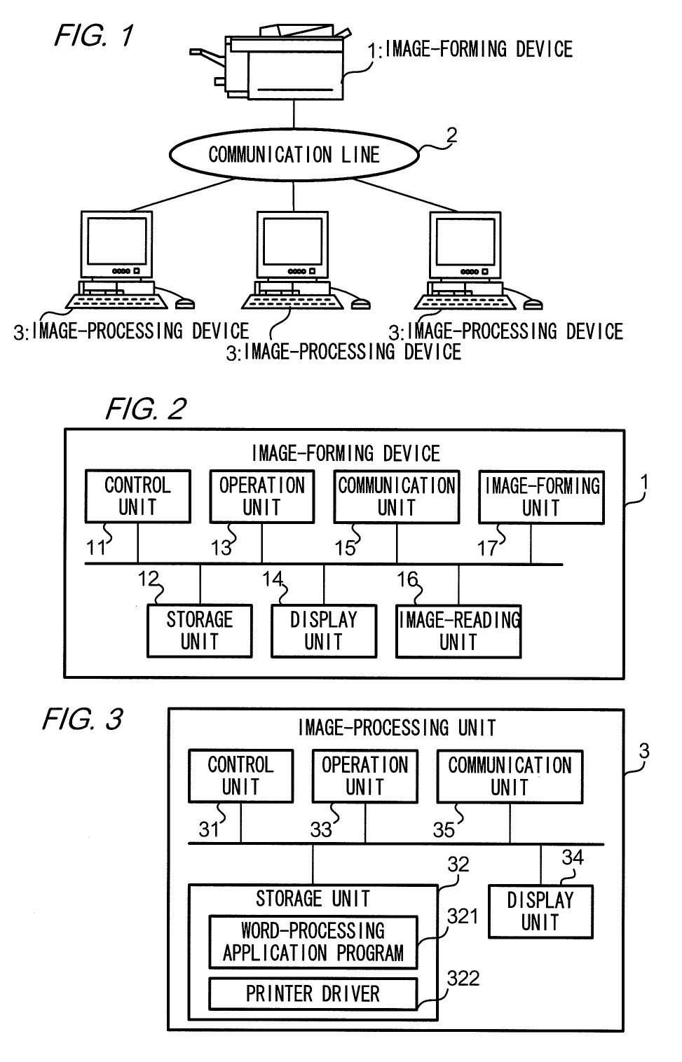

FIG. 1 is a diagram showing an entire configuration of a system according to the present exemplary embodiment. Image-forming device 1 and image-processing devices 3 are connected with each other via communication line 2, which is, for example, a LAN (Local Area Network). Image-forming device 1 has functions of copying, image forming, and image reading. Image-processing devices 3 may be personal computers, which have a function of image processing. Image-processing devices 3 also have a function of providing image-forming device 1 with image data via communication line 2, and providing image-forming device 1 with an instruction to form an image on the basis of the image data. Although FIG. 1 shows a single image-forming device 1 and three image-processing devices 3, there may be a different number of image-forming devices 1 and image-processing devices 3 connected to communication line 2.

FIG. 2 is a block diagram showing a configuration of image-forming device 1.

Image-forming device 1 includes control unit 11, storage unit 12, operation unit 13, display unit 14, communication unit 15, image-reading unit 16, and image-forming unit 17. Control unit 11 includes a CPU (Central Processing Unit), a ROM (Read Only Memory), and a RAM (Random Access Memory). The CPU executes a program stored in the ROM or storage unit 12 to control components of image-forming device 1. Storage unit 12 is a nonvolatile auxiliary storage device such as an HDD (Hard Disk Drive), which stores programs and data. Operation unit 13 includes plural keys, and in response to an operation by a user, outputs a signal corresponding to the operation to control unit 11. Display unit 14 includes a liquid crystal display and a liquid crystal driving circuit, and displays information on progress of a processing or guidance about an operation, on the basis of data provided from control unit 11. Communication unit 15 includes a communication interface, and communicates with image-processing device 3 via communication line 2.

Image-reading unit 16 includes an image pickup device such as a CCD (Charge Coupled Device), and causes the image pickup device to read an image formed on a recording sheet to generate image data representing the read image. Image-forming unit 17 includes a photosensitive drum for holding an image, an exposure unit that exposes the photosensitive drum on the basis of image data to form an electrostatic latent image on the drum, a developing unit that develops an electrostatic latent image to form a toner image, a transfer unit that transfers a toner image to a recording sheet, and a fixing unit that fixes a toner image transferred to a recording sheet, on the recording sheet. Image-forming unit 17 forms an image represented by image data generated by image-reading unit 16, or an image represented by image data received via communication unit 15, on a recording sheet. Namely, image-forming unit 17 forms an image represented by image data generated by an image-forming device, on a recording medium such as a recording sheet.

FIG. 3 is a block diagram showing a configuration of image-processing device 3.

Image-processing device 3 includes control unit 31, storage unit 32, operation unit 33, display unit 34, and communication unit 35. Control unit 31 includes a CPU (Central Processing Unit), a ROM (Read Only Memory), and a RAM (Random Access Memory). The CPU executes a program stored in the ROM and storage unit 32 to control components of image-processing device 3. Operation unit 33 includes a keyboard and a mouse, and in response to an operation by a user, provides control unit 31 with a signal corresponding to the operation. Display unit 34 may be a CRT (Cathode Ray Tube) or a liquid crystal display. Display unit 34 displays information on the basis of image data provided from control unit 31. Communication unit 35 includes a communication circuit and a communication interface, which communicates with image-forming device 1 via communication line 2.

Storage unit 32 is a nonvolatile auxiliary storage device such as an HDD (Hard Disk Drive), which stores programs and data. Storage unit 32 stores word-processing application program 321. Control unit 31, by following a procedure described in word processing application program 321, generates image data representing a document in which characters, graphics, and/or tables are arranged, in the RAM. Control unit 31 is an example of an obtaining unit that obtains image data.

Storage unit 32 also stores printer driver 322. Control unit 31, by following a procedure described in printer driver 322, converts image data generated using word-processing application program 321 into image data described in a page description language that can be interpreted by image-forming device 1. Printer driver 322 describes a range of a red color within an RGB color space. In the present exemplary embodiment, each color of RGB is represented in 256 shades, and a range of a red color is represented as follows: R=255, G=0 to 51, and B=0 to 51. Storage unit 32 is an example of a color storage unit that stores a range of a particular color within a color space.

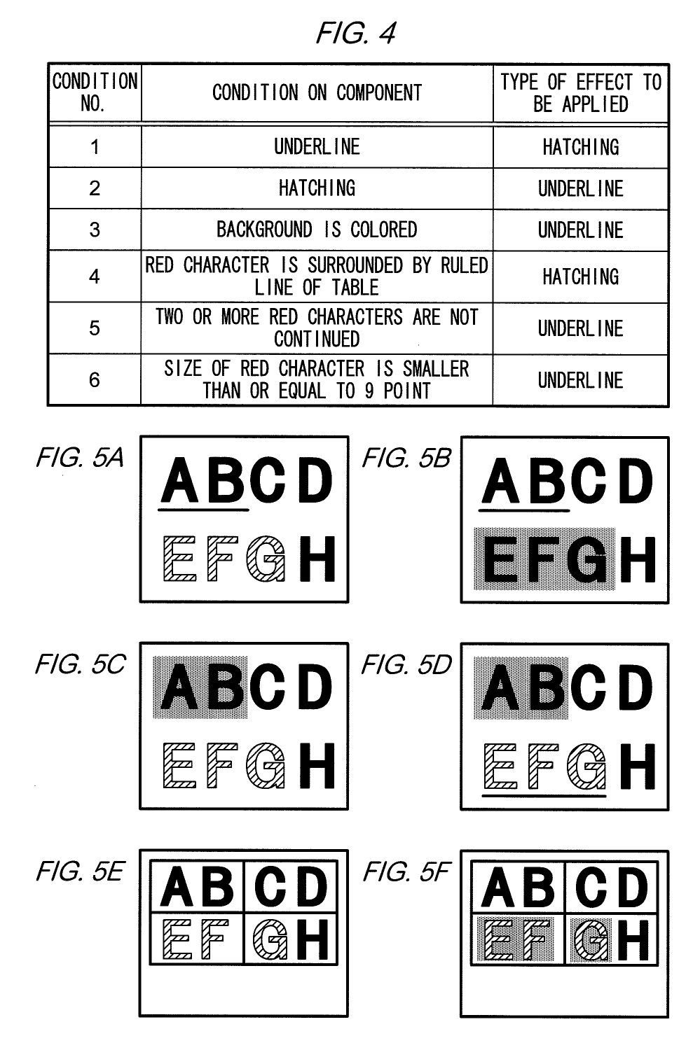

Printer driver 322 also describes sets of a condition on a component of an image and a type of effect to be applied to a red character included in an image having a component meeting the condition. FIG. 4 is a diagram showing data described in printer driver 322. Conditions on a component of an image include six patterns, as follows: “1. Underline,” “2. Hatching,” “3. Background is Colored,” “4. Red Character is Surrounded by Ruled Line of Table,” “5. Two or More Red Characters are not Continued,” and “6. Size of Red Character is Smaller Than or Equal to 9 Point.” The six conditions are associated with a type of effect “hatching,” “underline,” “underline,” “hatching,” “underline,” and “underline,” respectively.

Storage unit 32 is an example of an effect storage unit that stores a set of a condition on a component of an image and a type of effect to be applied to an area having a color falling within a particular range of a color, the area being included in an image having a component meeting the condition. Also, storage unit 32 is an example of an effect storage unit that can store information that an area of an image having a color falling within a particular range of a color is surrounded by a ruled line of a table, as a condition on a component of an image. Also, storage unit 32 is an example of an effect storage unit that stores a fact that a size of an area of an image having a color falling within a particular range of a color is smaller than or equal to a predetermined size, as a condition on a component of an image. Also, storage unit 32 is an example of an effect storage unit that stores a fact that a size of a character having a color falling within a particular range of a color is smaller than or equal to a predetermined size, as a condition on a component of an image.

Printer driver 322 also describes a procedure of an operation carried out by control unit 31 on image data generated using word-processing application program 321. In the operation, control unit 31 applies an effect to an area having a color falling within a range of a particular color, in an image represented by generated image data, thereby generating image data representing an image to which an effect is applied.

### (1-2) Operation

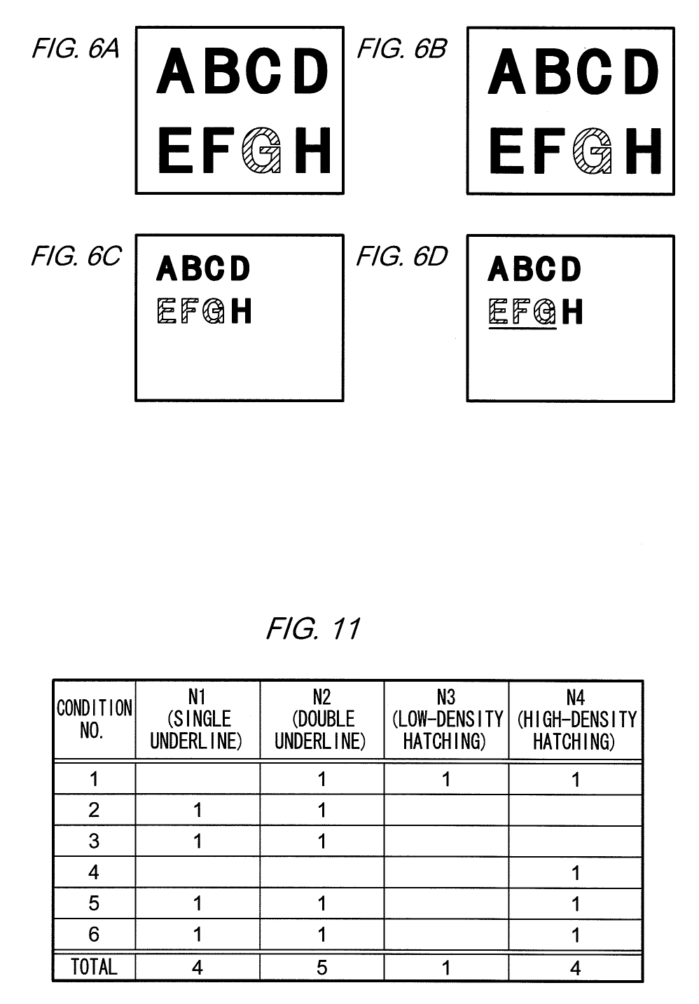

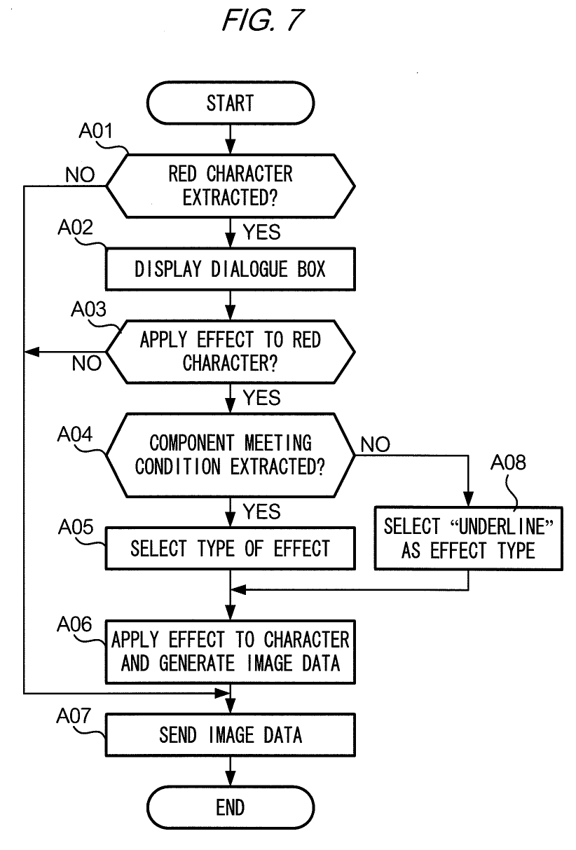

A user causes image-processing device 3 to execute word-processing application program 321, and while viewing an image displayed on display unit 34, prepares a document using operation unit 33. If there is a character to be emphasized in the document, the user provides image-processing unit 3 with an instruction to change the color of the character to red, using operation unit 33. FIG. 5A shows an example of a prepared document. In the document, three characters E, F, and G are represented in red, and the other characters are represented in black. Also, two characters A and B are underlined. Control unit 31, by following a procedure described in word-processing application program 321, generates image data corresponding to an operation by the user in a RAM. Subsequently, if an instruction to print the prepared document is given, control unit 31 executes printer driver 322 to start an operation shown in FIG. 7.

Control unit 31 initially extracts a red character in an image represented by image data (step A01). The image data may describe color information (gray levels of R, G, and B) specifying colors of characters shown in FIG. 5A and character information specifying faces of characters in association with each other. Control unit 31, by comparing the color information and a range of a red color described in printer driver 322, extracts a red character. In the case of the example shown in FIG. 5A, three characters E, F, and G are extracted as a red character. If a red character is extracted (step A01: YES), control unit 31 proceeds to an operation of step A02. If a red character is not extracted (step A01: NO), control unit 31 proceeds to step A07. Control unit 31 is an example of an area extraction unit that extracts an area having a color falling within a range of a color stored in a color storage unit, in an image represented by image data obtained by an obtaining unit.

FIG. 8 is a diagram showing dialogue box 5 displayed at step A02. Dialogue box 5 has radio buttons R51 and R52, and the user is able to select one of the buttons using operation unit 33. If the user selects radio button R51 corresponding to “YES”, and presses soft button B53 corresponding to “OK” (step A03: YES), control unit 31 proceeds to step A04. On the other hand, if the user selects radio button R52 corresponding to “NO”, and presses soft button B53 (step A03: NO), control unit 31 proceeds to step A07, without applying an effect to the red character.

At step A04, control unit 31 extracts a component meeting a condition stored in storage unit 32, in the image represented by the image data. The image data may describe character data representing faces of characters shown in FIG. 5A, effect data representing types of effect to be applied to the characters, and character size data representing sizes of the characters, in association with each other. Types of effect may include “underline”, “hatching”, and “coloring of background.” Character size data may be represented by a number of points. The image data may also describe ruled line data representing starting points and end points of ruled lines of a table. Control unit 31 reads out effect data, character size data, and ruled line data from the image data. Control unit 31 also determines whether the red character extracted at step A01 constitutes one of two or more consecutive red characters.

If a component meeting a condition (see FIG. 4) stored in storage unit 32 is extracted (step A04: YES), control unit 31 proceeds to an operation of step A05. If a component meeting a condition is not extracted (step A04: NO), control unit 31 proceeds to an operation of step A08. In the case of the example shown in FIG. 5A, an effect “underline” is extracted, and since the effect is a component meeting a condition stored in storage unit 32, control unit 31 proceeds to an operation of step A05. Control unit 31 is an example of a component extraction unit that extracts a component meeting a condition stored in an effect storage unit, in an image represented by image data obtained by an obtaining unit.

At step A05, control unit 31 determines a type of effect to be applied to the red character. To do so, control unit 31 reads a type of effect associated with the condition met by the component extracted at step A04, from storage unit 32. In the case of the example shown in FIG. 5A, a component “underline” is extracted, which corresponds to a condition “1. Underline” shown in FIG. 4. Since the condition is associated with a type of effect “hatching”, “hatching” is selected as a type of effect to be applied to a red character.

If a component meeting a condition shown in FIG. 5 is not extracted (step A04: NO), control unit 31 determines “underline” as a type of effect to be applied to the red character (step A08).

At step A06, control unit 31 writes data representing the type of effect determined at step A05 or step A08 in the image data in association with the character extracted at step A01. In the case of the example shown in FIG. 5A, since a type of effect is determined to be hatching at step A05, control unit 31 writes effect data indicating hatching in the image data in association with three characters E, F, and G Control unit 31 is an example of a generating unit that, if a component is extracted by a component extraction unit, that meets a condition stored in an effect storage unit, generates image data representing an image in which an effect of a type stored in the effect storage unit in association with the condition is applied to an area of the image extracted by an area extraction unit.

At step A07, control unit 31 converts the image data generated at step A06 into image data described in a page description language, and sends the image data and an instruction to form an image on the basis of the image data to image-forming device 1 via communication line 2.

When the image data and the instruction sent from image-processing device 3 is received by communication unit 15 of image-forming device 1, control unit 11 of image-forming device 1 converts the image data into bit-mapped image data, binarizes the bit-mapped image data, and provides image-forming unit 17 with the binarized image data. Image-forming unit 17 forms an image represented by the provided image data on a recording sheet. In the case of the example shown in FIG. 5A, since hatching is determined as a type of effect, an image is formed in which three characters E, F, and G are hatched, as shown in FIG. 5B.

Now, cases will be described, in which an effect other than underline is applied to an image of a document prepared using word-processing application program 321.

If an image includes hatching, as shown in FIG. 5C, an underline is determined as a type of effect to be applied to a red character, on the basis of a correspondence relation shown in FIG. 4. Similarly, if a background of an image is wholly or partially colored, an underline is determined as a type of effect.

If a red character is surrounded by a ruled line of a table, as shown in FIG. 5E, hatching is determined as a type of effect to be applied to the red character, as shown in FIG. 51.

If two or more red characters are not continued, as shown in FIG. 6A, an underline is determined as a type of effect to be applied to a red character, as shown in FIG. 6B.

If the size of a red character is smaller than or equal to 9 point, as shown in FIG. 6C, an underline is determined as a type of effect to be applied to the red character, as shown in FIG. 6D.

### (2) Second Exemplary Embodiment

The present exemplary embodiment is a partially modified version of the first exemplary embodiment. Hereinafter, differences between the present exemplary embodiment and the first exemplary embodiment will be described.

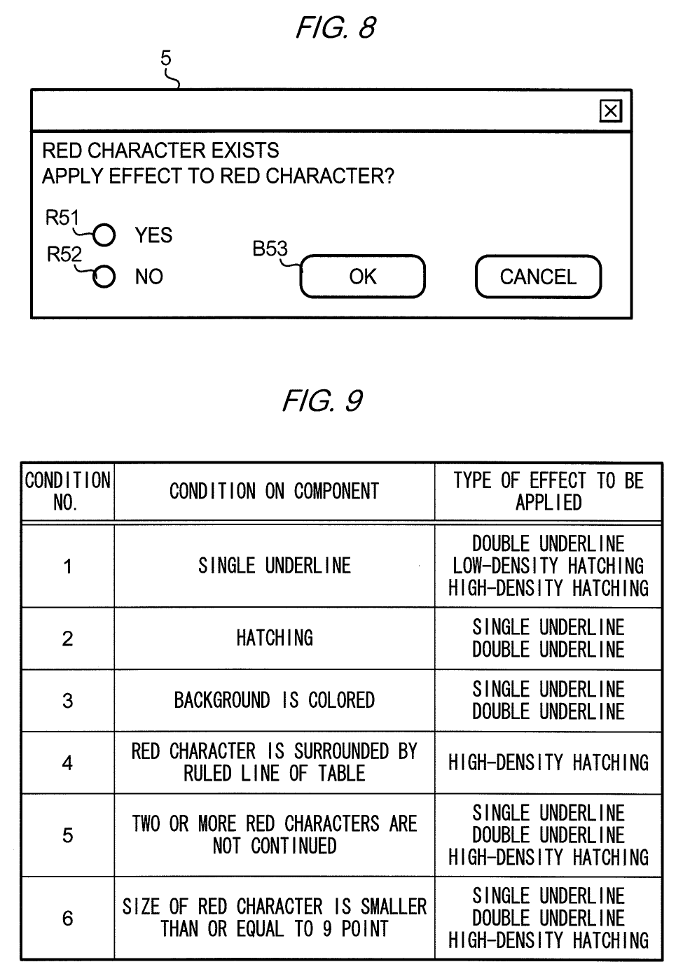

Printer driver 322 describes sets of a condition on a component of an image and a type of effect to be applied to a red character included in an image having a component meeting the condition. FIG. 9 is a diagram showing data described in printer driver 322. Conditions on a component of an image include six patterns, as follows: “1. Single Underline,” “2. Hatching,” “3. Background is Colored,” “4. Red Character is Surrounded by Ruled Line of Table,” “5. Two or More Red Characters are not Continued,” and “6. Size of Red Character is Smaller Than or Equal to 9 Point.” The six conditions are associated with a type of effect “double underline, low-density hatching, high-density hatching,” “single underline, double underline,” “single underline, double underline,” “high-density hatching,” “single underline, double underline, high-density hatching,” and “single underline, double underline, high-density hatching,” respectively.

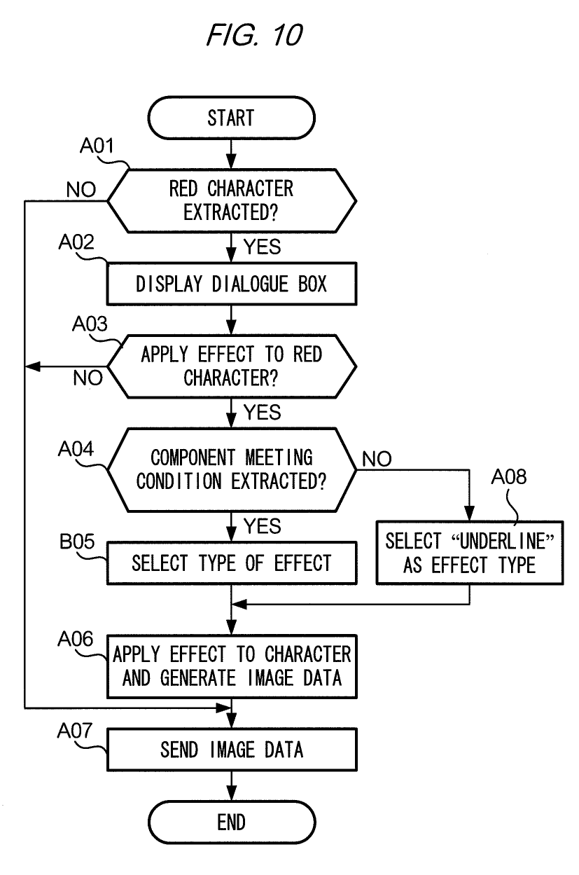

FIG. 10 is a diagram showing a procedure of an operation carried out by control unit 31. Operations of steps A01 to A04 are identical to those of the first exemplary embodiment.

At step B05, control unit 31 initially resets counters N1, N2, N3, and N4 to zero, which are associated with effects, single underline, double underline, low-density hatching, and high-density hatching, respectively. Subsequently, control unit 31 reads out for each condition corresponding to a component extracted at step A04, a corresponding type of effect from storage unit 32, and counts a number for each type of effect, in which a type of effect is read, using a counter. For example, if at step A04, an effect, single underline, is extracted, corresponding types of effect, double underline, low-density hatching, and high-density hatching, are read out from storage unit 32, and accordingly values of the counters are set as follows: N1=0, N2=1, N3=1, and N4=1. In the present example, it is assumed that after all components meeting any one of the conditions shown in FIG. 9 are extracted at step A04, values of the counters are set as shown in FIG. 11.

Subsequently, control unit 31 selects a type of effect corresponding to a counter that counts a highest total value, as a type of effect to be applied to a red character. In the present example, since it is assumed that the highest value is “5” of counter N2, control unit 31 selects a corresponding type of effect, double underline, as a type of effect to be applied to a red character, and proceeds to an operation of step A06. The operation of step A06 and subsequent operations are identical to those of the first exemplary embodiment. In the present exemplary embodiment, a type of effect to be selected in a situation where plural counters count an identical highest value may be predetermined. For example, a type of effect corresponding to a counter to which a lowest number is assigned after character “N” may be selected. In this case, if counters N2 and N4 count an identical highest value, a corresponding type of effect, double underline, is selected.

Control unit 31 is an example of a selecting unit that, if plural components are extracted by a component extraction unit, that meet any one of conditions stored in an effect storage unit, reads out for each condition corresponding to each of the extracted components, a corresponding type of effect from the effect storage unit, counts a number for each type of effect, in which a type of effect is read, and selects a type of effect that is most frequently read from the effect storage unit, as a type of effect to be applied to an area of an image extracted by an area extraction unit. Also, control unit 31 is an example of a generating unit that generates image data representing an image in which an effect of a type selected by a selecting unit is applied to an area of the image extracted by an area extraction unit.

### (3) Third Exemplary Embodiment

The present exemplary embodiment is a partially modified version of the first exemplary embodiment. Hereinafter, differences between the present exemplary embodiment and the first exemplary embodiment will be described.

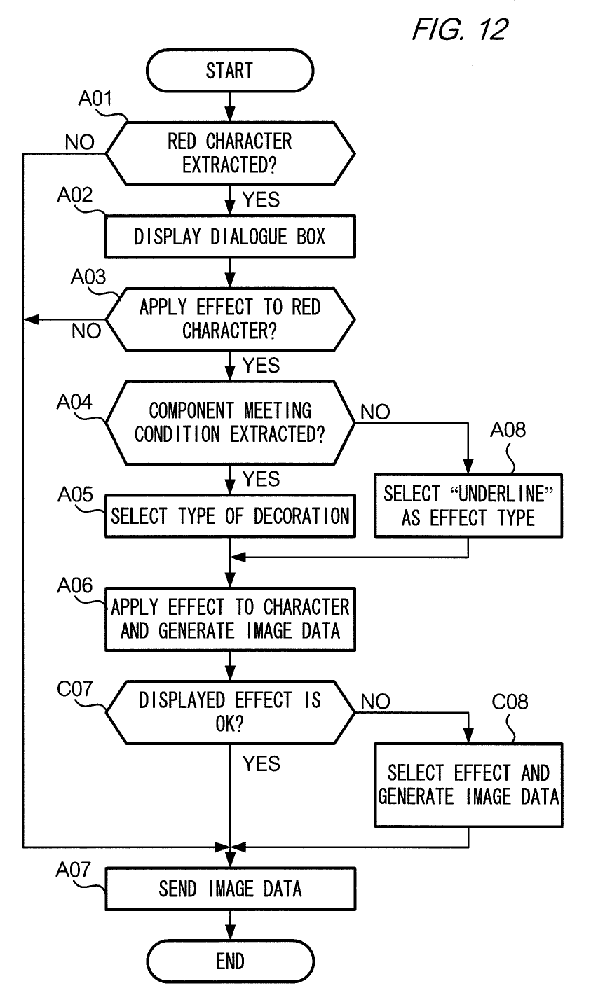

FIG. 12 is a diagram showing a procedure of an operation carried out by control unit 31. Operations of steps A01 to A06, and step A08 are identical to those of the first exemplary embodiment.

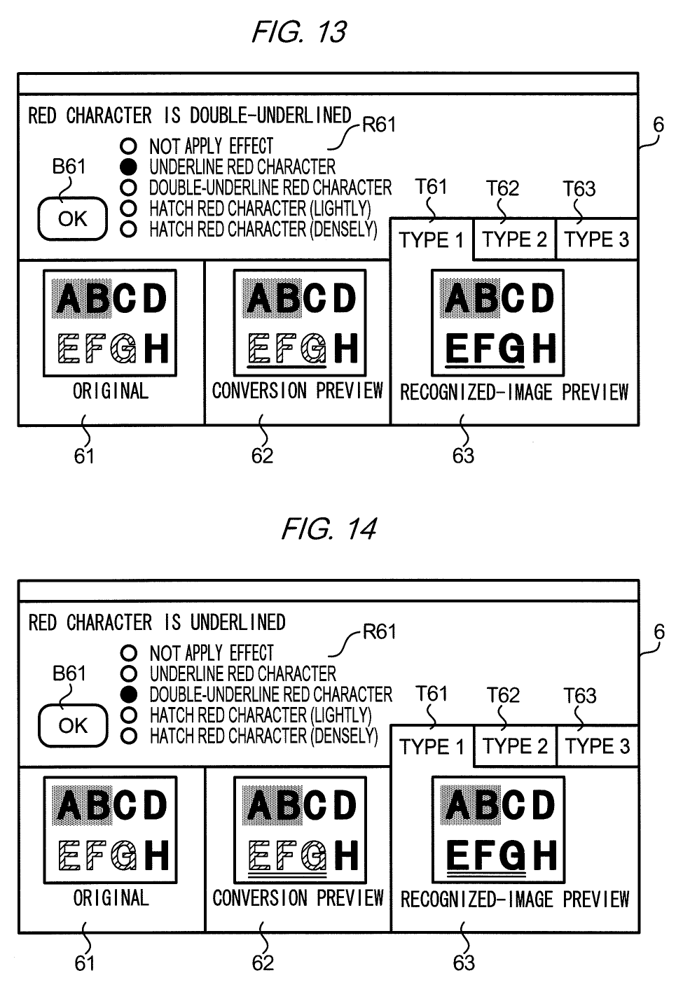

At step C07, control unit 31 displays dialogue box 6 on display unit 34, as shown in FIG. 13, in which an image represented by image data generated at step A06 is arranged. At the upper left of dialogue box 6, a type of effect determined by control unit 31 is indicated by a message “Red Character is Double-Underlined.” At lower left area 61 of dialogue box 6, an original image is displayed, in which an effect is not yet applied to a red character. At lower center area 62 of dialogue box 6, a conversion preview is displayed, that shows an image in which an effect to a red character is applied.

At lower right area 63 of dialogue box 63, a recognized-image preview is displayed, which shows an image represented using a color recognized by a person having color weakness. Storage unit 32 stores data on a color to be recognized by a person having color weakness when s/he views a red color. Control unit 31 processes an image represented by image data generated at step A06 so that a red color of the image is changed to a color recognized by a person having color weakness when s/he views a red color, and displays the processed image on display unit 34.

Storage unit 32 is an example of a second color storage unit that stores a color to be recognized by a person having a particular type of color vision when the person views a color falling within a range of a color stored in a color storage unit. Control unit 31 is an example of a display unit that processes an image represented by an image data generated by a generating unit so that a color of an area of the image extracted by an area extraction unit is changed to a color stored in a second storage unit, and displays the processed image.

Display of a recognized-image preview may be changed depending on a type of color vision. Storage unit 32 may store for each type of color vision, a color to be recognized by a person having a particular color vision when s/he views a red color. Color vision may be classified into three types: type 1 color vision, type 2 color vision, and type 3 color vision. In this case, storage unit 32 may store a dark brown color in association with type 1 color vision, a brown color in association with type 2 color vision, and a red-purple color in association with type 3 color vision. Dialogue box 6 has three tabs T61, T62, and T63 for selecting one of type 1 color vision, type 2 color vision, and type 3 color vision. If type 1 color vision is selected, a red color is changed to a dark brown color, if type 2 color vision is selected, a red color is changed to a brown color, and if type 3 color vision is selected, a red color is changed to a red-purple color, before an image is displayed.

If soft button B61 corresponding to “OK” shown in the upper left of dialogue box 6 is pressed, control unit 31 proceeds to an operation of step A07. The operation of step A07 is identical to that of the first exemplary embodiment. If the operation of step A07 is carried out, an image represented by image data generated at step A06 is formed on a recording sheet.

Storage unit 32 is an example of a second color storage unit that stores for each type of color to be recognized by persons having a particular type of color vision when the persons view a color falling within a range of a color stored in a color storage unit. Control unit 31 is an example of a specification receiving unit that receives a specification of a type of color vision. Also, control unit 31 is an example of a reading unit that reads out a color from a second color storage unit, which corresponds to a type of color vision specified using a specification receiving unit. Also, control unit 31 is an example of a display unit that processes an image represented by an image data generated by a generating unit so that a color of an area of the image extracted by an area extraction unit is changed to a color read out by a reading unit, and displays the processed image.

On the other hand, if one of radio buttons R61 displayed at the upper center of dialogue box 6 is selected, control unit 31 proceeds to an operation of step C08. At step C08, control unit 31 displays an image to which a selected effect is applied, in an area each of a conversion preview and a recognized-image preview. FIG. 14 is a diagram showing an image to be displayed when double-underline is selected.

Control unit 31 is an example of a second specification receiving unit that receives a specification of a type of effect. Also, control unit 31 is an example of a second generating unit that generates image data representing an image in which an effect of a type specified using a second specification receiving unit is applied to an area of the image extracted by an area extraction unit.

### (4) Modifications

Modifications described below may be combined with each other.

### (Modification 1)

The second exemplary embodiment and the third exemplary embodiment may be combined with each other. Specifically, the operations from step C07 of FIG. 12 may be carried out after the operation of step A06 of FIG. 10.

### (Modification 2)

In the above exemplary embodiments, a range of a red color is stored in storage unit 32, and an effect is applied to a character having a color falling within the range. In the exemplary embodiments, a range of any color may be stored in storage unit 32. A person having color weakness has difficulty in recognizing a range of a given color. Such a person may not be able to realize a difference in color between a character represented in a certain range of a color other than black and a character represented in black. Accordingly, a range of a color stored in storage unit 32 may be determined on the basis of a range of a color that is difficult to recognize for a person having color weakness.

It is to be noted that although color weakness is classified into several types on the basis of a range of a color that is difficult to recognize, it is said that a rate of persons having difficulty in recognizing a red color is relatively high. Also, when a character string is represented in a color other than black to highlight it, a red color is commonly used. Accordingly, storing a range of a red color in storage unit 32 is preferable.

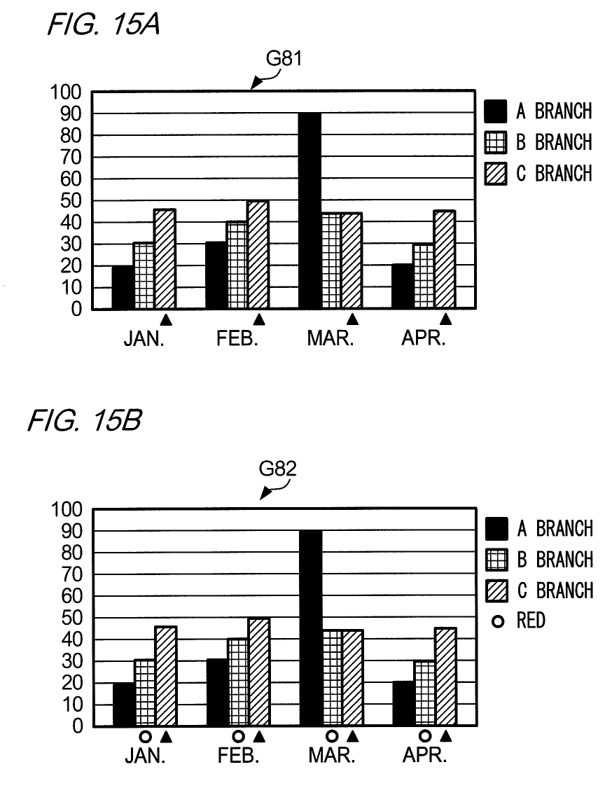

In the above exemplary embodiments where an effect is applied to a character, an effect may be applied to an image such as a graphic or a table. FIGS. 15A and 15B are diagrams showing an effect applied to a bar chart. Bar chart G81 shown in FIG. 15A is a pre-processed chart. In the chart, a bar corresponding to A branch is represented in black, a bar corresponding to B branch is represented in red, and a bar corresponding to C branch is represented in green. Also, to highlight bars corresponding to C branch, triangular symbols are shown below the bars. In the case of the example shown in FIG. 15A, if a triangular symbol is stored in storage unit 32 as a condition on a component of an image, and a circular symbol is stored in storage unit 32 in association with the triangular symbol, as a type of effect to be applied to an image, circular symbols are added below bars corresponding to B branch, as shown in bar chart G82 of FIG. 15B which is a processed chart.

### (Modification 4)

In the above exemplary embodiments where the fact that two or more red characters are not continued is stored in storage unit 32 as a condition on a component of an image, the fact that a red area is smaller than or equal to a predetermined value may be instead stored in storage unit 32 as a condition on a component of an image. If the latter condition is stored in storage unit 32, control unit 31 calculates a red area in an image represented by image data, and if the calculated area is smaller than or equal to a predetermined value, applies an effect associated with the condition to the area.

### (Modification 5)

In the above exemplary embodiments where control unit 31 of image-processing device 3 applies an effect to an image by executing printer driver 322, a program describing a procedure of the operation may be stored in storage unit 12 of image-forming device 1, and the operation may be carried out by control unit 11. If the configuration is employed, an effect may be applied to an image represented by image data representing an image read by image-reading unit 16. Accordingly, an image with an effect may be obtained even in a case that an image formed on a recording sheet is copied.

Also, an ASIC (Application Specific Integrated Circuit) for carrying out the above operation may be provided in image-processing device 3.

### (Modification 6)

In the above exemplary embodiments where a range of a particular color is represented by gray levels of an RGB color space, a range of a particular color may be represented in a color space such as an HLS color space representing a color in hue, saturation, and lightness.

The foregoing description of the exemplary embodiments of the present invention has been provided for the purposes of illustration and description. It is not intended to be exhaustive or to limit the invention to the precise forms disclosed. Obviously, many modifications and variations will be apparent to practitioners skilled in the art. The embodiments were chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. An image-processing device comprising:
a color storage unit that stores a range of a color within a color space;
an effect storage unit that stores a set of a condition on a component of an image and a type of effect to be applied to an area having a color falling within the range of a color stored in the color storage unit, the area being included in an image having a component meeting the condition;
an obtaining unit that obtains image data;
an area extraction unit that extracts an area having a color falling within the range of a color stored in the color storage unit, in an image represented by the image data obtained by the obtaining unit;
a component extraction unit that extracts a component meeting the condition stored in the effect storage unit, in the image represented by the image data obtained by the obtaining unit; and
a generating unit that if a component is extracted by the component extraction unit, that meets the condition stored in the effect storage unit, generates image data representing an image in which an effect of the type stored in the effect storage unit in association with the condition is applied to the area extracted by the area extraction unit.

2. The image-processing device according to claim 1, wherein the effect storage unit stores a plurality of sets of a condition on a component of an image and a type of effect to be applied to an area having a color falling within the range of a color stored in the color storage unit, the area being included in an image having a component meeting the condition,
the image-processing device further comprising a selecting unit that if a plurality of components are extracted by the component extraction unit, that meet any one of the conditions stored in the effect storage unit, reads out for each condition corresponding to each of the extracted components, a corresponding type of effect from the effect storage unit, counts a number for each type of effect, in which a type of effect is read, and selects a type of effect that is most frequently read from the effect storage unit, as a type of effect to be applied to the area extracted by the area extraction unit, wherein
the generating unit generates image data representing an image in which an effect of the type selected by the selecting unit is applied to the area extracted by the area extraction unit.

3. The image-processing device according to claim 1, wherein the effect storage unit stores a fact that an area of an image having a color falling within the range of a color stored in the color storage unit is surrounded by a ruled line of a table, as a condition on a component of an image.

4. The image-processing device according to claim 1, wherein the effect storage unit stores a fact that a size of an area of an image having a color falling within the range of a color stored in the color storage unit is smaller than or equal to a predetermined size, as a condition on a component of an image.

5. The image-processing device according to claim 1, wherein the effect storage unit stores a fact that a size of a character having a color falling within the range of a color stored in the color storage unit is smaller than or equal to a predetermined size, as a condition on a component of an image.

6. The image-processing device according to claim 1, further comprising:
a second color storage unit stores a color to be recognized by a person having a particular color vision when the person views a color falling within the range of a color stored in the color storage unit; and
a display unit that processes the image represented by the image data generated by the generating unit so that a color of the area of the image extracted by the area extraction unit is changed to the color stored in the second storage unit, and displays the processed image.

7. The image-processing device according to claim 6, wherein the second color storage unit stores for each of types of color to be recognized by persons having a particular color vision when the persons view a color falling within the range of a color stored in the color storage unit,
the image-processing device further comprising:
a specification receiving unit that receives a specification of a type of color vision; and
a reading unit that reads out a color from the second color storage unit, that corresponds to the type of color vision specified using the specification receiving unit, wherein
the display unit processes the image represented by the image data generated by the generating unit so that a color of the area of the image extracted by the area extraction unit is changed to the color read out by the reading unit, and displays the processed image.

8. The image-processing device according to claim 6, further comprising:
a second specification receiving unit that receives a specification of a type of effect; and
a second generating unit that generates image data representing an image in which an effect of the type specified using the second specification receiving unit is applied to the area extracted by the area extraction unit.

9. An image-forming device comprising:
the image-processing device according to claim 1; and
an image-forming unit that forms an image on a recording sheet, represented by image data generated by the image-processing device.

10. An image-processing method comprising:
obtaining image data;
extracting an area having a color falling within a particular range of a color, in an image represented by the obtained image data;
extracting a component meeting a predetermined condition on a component of an image, in the image represented by the obtained image data; and
if a component meeting the predetermined condition is extracted, generating image data representing an image in which an effect of a type associated with the predetermined condition is applied to the extracted area.

11. A computer readable medium storing a program causing a computer to execute a process for image-processing, the computer comprising:
a color storage unit that stores a range of a color within a color space; and
an effect storage unit that stores a set of a condition on a component of an image and a type of effect to be applied to an area having a color falling within the range of a color stored in the color storage unit, the area being included in an image having a component meeting the condition, the process comprising:
obtaining image data;
extracting an area having a color falling within the range of a color stored in the color storage unit, in an image represented by the obtained image data;
extracting a component meeting the condition stored in the effect storage unit, in the image represented by the obtained image data; and
if a component is extracted, that meets the condition stored in the effect storage unit, generating image data representing an image in which an effect of the type stored in the effect storage unit in association with the condition is applied to the extracted area.
